(19) United States
(12) Patent Application Publication
(10) Pub. No.: US 2008/0116847 A1
(43) Pub. Date: May 22, 2008

(54) SYSTEMS AND METHODS FOR WIRELESS POWER TRANSFER

(75) Inventors: Siew Ling Loke, London (GB); Eng Hua Lee, London (GB); Raif M. Awaida, London (GB)

Correspondence Address: KNOBBE MARTENS OLSON & BEAR LLP, 2040 MAIN STREET, FOURTEENTH FLOOR, IRVINE, CA, 92614, US

(73) Assignee: Bio Aim Technologies Holding Ltd., Tortola (VG)

(21) Appl. No.: 11/844,242

(22) Filed: Aug. 23, 2007

Related U.S. Application Data
(60) Provisional application No. 60/950,192, filed on Jul. 17, 2007.
(60) Provisional application No. 60/841,759, filed on Sep. 1, 2006.
(60) Provisional application No. 60/894,581, filed on Mar. 13, 2007.

(51) Int. Cl. H02J 7/00; H01F 38/00

(52) U.S. Cl. 320/108; 307/104

(57) ABSTRACT

Systems and methods for wireless power transfer are disclosed. Primary windings generate magnetic fields which are inductively coupled to secondary windings to transfer power in a wireless manner. One embodiment includes a plurality of tiles of magnetic cores and windings for the primary windings. The tiles can be arranged in a magnetic segment with windings of tiles being orthogonal with respect to windings of adjacent tiles. For example, a winding of a first tile can be horizontal, and windings of adjacent tiles can be vertical. One embodiment further groups these magnetic segments into larger entities, wherein each magnetic segment can be independently activated. One embodiment includes a magnetic amplifier or an electronic device for secondary side control of power. This permits multiple devices to be powered or charged to be able to regulate power or charging independently from one another.

### CROSS-REFERENCE TO RELATED APPLICATIONS

This application claims the benefit under 35 U.S.C. § 119(e) of U.S. Provisional Application No. 60/841,759, filed on Sep. 1, 2006; U.S. Provisional Application No. 60/894,581, filed on Mar. 13, 2007; and U.S. Provisional Application No. 60/950,192, filed on Jul. 17, 2007, the entire disclosures of which are hereby incorporated by reference.

This application is related to copending application titled THREE-DIMENSIONAL ELECTROMAGNETIC FLUX FIELD GENERATION, Ser. No. ______ [Attorney Docket No. RAIF.004A], filed on the same date as the present application, the entirety of which is hereby incorporated by reference.

### BACKGROUND OF THE INVENTION

1. Field of the Invention

The invention generally relates to electronics, and in particular, to wireless charging.

2. Description of the Related Art

Portable devices has proliferated over the past ten years. For the purpose of cost and convenience these devices rely on secondary power cells which can be recharged for example laptop computers, mobile telephones, electrical toothbrushes, shavers and personal digital assistant. Many of these devices are charged via electrical contacts and power supplies that take power from the mains and convert into a level suitable for each individual device.

Conventional techniques for power conversion and electrical connection vary considerable from manufacturer to manufacturer. Therefore, for consumers who own several of these devices are required to own or carry around several different types of adaptors which can be cumbersome when traveling or trying to find enough sockets to plug them into. Moreover, these devices have open electrical contacts that can be damaged in water or exposed to other chemicals and therefore inappropriate to be used by hard wearing users. In recent years, some attempts have been made to overcome the foreseeable problems.

Inductive transference of energy or power has been used for many years in the form of transformers in switched mode power supplies. They include a primary circuit that generates electromagnetic flux field and fixed secondary circuits those receive inductively coupled power.

Wireless power transfer has become a very attractive solution with the proliferation of portable devices over the past ten years. With these devices for instant mobile phones, toothbrushes, PDA or laptop computers reliant on rechargeable secondary powered cells, it may not always be convenient or safe to have open electrical contacts. The wireless connection provides a number of advantages over conventional hardwired connections. A wireless connection can reduce the chance of shock and can provide a relatively high level of electrical isolation between the power supply circuit and the secondary circuit. Inductive couplings can also make it easier for a consumer to replace limited-life components. Secondary devices can be completely sealed to ensure safety when used in damp or wet surroundings for example bathroom, kitchen or even swimming pool. This wireless solution is not only limited to portable devices. Many devices like game consoles, DECT phones or even a lamp can benefit from cutting the cords. As there many wireless communication platforms that already exist or upcoming like Bluetooth, NFC, WIFI, UWB, GSM etc., the only physical connection left is the power supply.

Wireless inductive charging of portable devices is divided into two categories. The first category is indirect charging, where the wireless electronics supplies power to secondary of the charging circuitry of a portable device which in turn will charge its battery accordingly. The second category is direct charging, where the secondary of the wireless inductive charging electronics are connected (contacted) to the battery directly supplying the charging current. Direct charging is typically more efficient as it has less circuitry for power loss to occur. However, direct charging is physically difficult to implement using wireless technology on existing portable devices. Many portable or handheld devices are built to a compact specification. Portable devices typically do not have room for any additional circuitry.

Prior techniques of non-contact battery charging include a technique whereby an inductive coil on the primary side aligns with a horizontal inductive coil on a secondary device when the device is placed into a cavity on the primary side that ensures precision in the alignment, which is crucial to achieving effective power transfer. A device that uses this technique includes the Braun Oral B Plak Control toothbrush. However, this system requires the secondary devices to be axially aligned with the primary unit. Existing wireless chargers are typically also uniquely designed by each individual manufacturer and typically cannot be used interchangeably.

Examples of wireless power transfer include U.S. Pat. No. 3,938,018 to Dahl; U.S. Pat. No. 5,959,433 to Rohde; U.S. Pat. No. 4,873,677 to Sakamoto, et al.; U.S. Pat. No. 5,952,814 to Van Lerberghe; U.S. Pat. No. 6,208,115 to Binder; WO 00/61400; WO 95/11545; GB2399225; GB2399226; GB2399227; GB2399228; GB2399229; GB2399230; U.S. Pat. No. 5,519,262 to Wood; U.S. Pat. No. 5,703,461 to Minoshima, et al.; U.S. Pat. No. 6,906,495 to Cheng, et al.; U.S. Pat. No. 7,123,450 to Baarman, et al.; U.S. Pat. No. 4,675,615 to Bramanti; U.S. Pat. No. 5,952,814 to Van Lerberghe; U.S. Pat. No. 7,211,986 B1 to Flowerdew et al.; and U.S. Pat. No. 7,215,096 B2 to Miura et al.

### SUMMARY OF THE INVENTION

Embodiments of the invention can resolve the matter of cost, size and efficiency. Embodiments can be modular giving the possibility of for user to customize to their requirements with ease. It is flexible, where it can be mould to any shapes and sizes. It is also intelligent, it can detect when and where power is used, keeping auxiliary power losses to the minimum.

A first embodiment is used as a battery charger to recharge a system of biometrics security card for used in airports. The primary is assembly can be mould onto the dashboard of vehicles, staff desks and ticketing or reservation counters using anti slip material as the surface. The secondary is mounted to the biometrics security card which has to be intrinsically safe. Multiple cards can be charged at the same time. The cards can be charged regardless of their orientation due to the rotating magnetic field produced by a thin 2-dimensional surface using a single layer multi-filar stacking technique.

A second embodiment is used as a single or multiple mobile phones charger. With a minute secondary charging circuit placed within the mobile phone, the phone can be charged when placed in the vicinity of the magnetic field regardless of orientation. The charging surface can be customized to the size used. In the event when the charging surface is larger than the required area of the mobile phone, the inductive power transfer will be localized to the device itself. This aspect reduces unnecessary power generation and its resulting losses.

One aspect is in a flexibility which is achieved using micro-tiles high permeability ferrites to form the magnetic core used as the charging surface. This charging surface is powered as the primary of the of the magnetic flux field with power electronics circuitry.

A second aspect is in this power circuitry, where anti-saturation reset inductive toroidal cores are used should the primary experience a phenomenon called the staircase saturation, which is normally the main reason for component failures. This technique prevents heating of the ferrite cores and as a result smaller and lower rated components can be used.

A third aspect is in the winding technique where a single layer multi-filiar technique is used to achieve a rotating magnetic flux field with the assistance of a unique power circuitry design. This rotating field is what enables the power transference to occur successfully regardless of orientation of the secondary assembly.

A fourth aspect is modularity, where a virtually unlimited number of micro-tiles can be stacked or removed in segments without drastically changing the operation characteristics. This is useful when expansion is required.

One embodiment has the intelligence to know if a secondary device is present using Near Field Communication (NFC). If a device is not present, the magnetic field on the charging surface will seize enters a standby mode. It will be powered up again when a secondary device is placed in the vicinity of the field. With this feature, it also allows localized charging. As mentioned before, due to the micro-tiles configuration and the unique winding technique, the larger charging surfaces are divided into various segments. These segments can be controlled separately and only the area that is required will have a magnetic field available for inductive power transfer. These segments can have adjustable field strengths to meet a variety of device power requirements.

In one embodiment, the wireless electronics for charging of one or more battery cells is integrated with the cells into a battery pack. This permits a consumer has to procure these battery packs to render their portable device compatible with wireless inductive charging. This is also good for manufacturers, as a wireless inductive charging feature can be provided by incorporating the charging circuitries into the battery packs.

One embodiment of the invention is a battery pack that includes winding coils that receive power and charging electronics. The battery pack can be used with a magnetic amplifier that performs closed loop control that is independent of the primary charging device.

One embodiment of the invention harnesses an inductive or contactless power transfer technique for charging rechargeable battery packs. In a secondary unit, power is received wirelessly through magnetic induction from a primary unit. This secondary unit includes coil windings and electronic circuitries can be installed into various types of portable devices where battery charging takes place. One feature is the embedment of the secondary unit into the battery packs themselves. By integrating the secondary unit of a contactless charger into the battery packs themselves, all a consumer would need to do to embrace the wireless power technology is to replace the battery packs.

There can be other aspects of an embodiment of the invention. Apart from incorporating the winding coils and the electronic circuitries into battery packs, there is also the adaptive control technique called parameter scheduling used for optimizing the power transfer. This technique is designed in such a way that a universal control algorithm can be employed for battery types of varying characteristics, such as, but not limited to, lithium polymer, lithium ion, nickel-cadmium, nickel metal hydride, or the like.

Another aspect is introduction of a component; a saturable inductor commonly known as a magnetic amplifier in the secondary of the charging electronics. In one embodiment, an electronic switch such as a MOSFET and a post regulating control circuit replaces the saturable inductor. These components can render the control of the secondary unit independent of the primary charging surface. This feature is particularly useful in the event when multiple devices are being charged on the same primary surface.

One embodiment is an apparatus for providing wireless charging, wherein the apparatus includes: a magnetic segment of 2 or more tiles, each tile having at least one winding having at least one turn, each time having a core of high magnetic permeability material, the magnetic segment having at least a first group of one or more tiles having winding(s) oriented in a first direction and a second group of one or more tiles having winding(s) oriented in a direction different than the first direction; and an inverter configured to power the windings of the tiles. In one embodiment, the gap is between about 0.5 mm and 2 mm. In one embodiment, the core is about 5 mm to about 30 mm in length and/or width.

One embodiment is a method of providing wireless charging, wherein the method includes: generating an AC magnetic field from a magnetic segment, the magnetic segment comprising 2 or more tiles, each tile having at least one winding having at least one turn, each time having a core of high magnetic permeability material, the magnetic segment having at least a first group of one or more tiles having winding(s) oriented in a first direction and a second group of one or more tiles having winding(s) oriented in a direction different than the first direction; and generating AC current to power the windings of the tiles.

One embodiment is an apparatus for receiving wireless power transfer, wherein the apparatus includes: a winding configured to inductively couple power in a wireless manner; a regulating device disposed in a current path of the winding; a rectifier circuit configured to rectify alternating current from the winding; and a control circuit configured to control operation of the regulating device for regulation of at least one of voltage, current, or power received from the winding.

One embodiment is a method for receiving wireless power transfer, wherein the method comprising: wirelessly inductively coupling to a source of power, thereby generating an internal source of alternating current; controlling a regulating device or an electronic circuit disposed in a current path of the alternating current to regulate at least one of power, voltage, or current; and rectifying the alternating current.

### BRIEF DESCRIPTION OF THE DRAWINGS

These drawings and the associated description herein are provided to illustrate specific embodiments of the invention and are not intended to be limiting.

FIG. 1 illustrates an embodiment of a base station system for wireless power transfer.

FIG. 2 illustrates an example of an inverter circuit.

FIG. 3 illustrates an example of an anti-saturation inductor.

FIG. 4A illustrates an example of the inverter circuit with the anti-saturation inductor.

FIG. 4B illustrates an example of a secondary circuit.

FIG. 5 illustrates a segment for a magnetic charging surface.

FIG. 6 illustrates a magnetic flux field generated by the currents of the horizontally-drawn windings of the cores.

FIG. 7 illustrates a magnetic flux field generated by the currents of the vertically-drawn windings of the cores.

FIG. 8A illustrates rotation of a magnetic field.

FIG. 8B illustrates a perspective view of separate windings around a magnetic core.

FIG. 9 illustrates a simulation of a resulting field sweeping in all directions.

FIG. 10 illustrates near field communication technology.

FIG. 11 illustrates connection for two magnetic segments.

FIG. 12 illustrates a top view of a charging surface with a plurality of magnetic segments.

FIG. 13 illustrates a B-H characteristic of a core.

FIG. 14 illustrates a buck-boost converter for powering a magnetic segment.

FIG. 15A illustrates a side view of power transfer from 2 C-shaped cores with an air gap to a floating device (with secondary windings).

FIG. 15B illustrates a side view of power transfer from micro-tiles to a floating device having secondary windings.

FIG. 16 illustrates an embodiment with an array of relay switches to control the activation of a magnetic segment.

FIG. 17 illustrates a micro-tile array in a 3-dimension form factor.

FIG. 18 illustrates a prophetic example of a wireless headset on a micro-tile array.

FIG. 19 depicts an example of a fly-back converter topology with a magnetic amplifier.

FIG. 20 illustrates an example of operation without the magnetic amplifier.

FIG. 21 illustrates an example of a charging profile.

FIG. 22 illustrates an example of operation of the fly-back converter topology.

FIG. 23 illustrates a circuit for reset of the magnetic amplifier.

FIG. 24 illustrates an example of an electronic post regulating circuit, which can be used in place of a magnetic amplifier.

### DETAILED DESCRIPTION OF THE PREFERRED EMBODIMENT

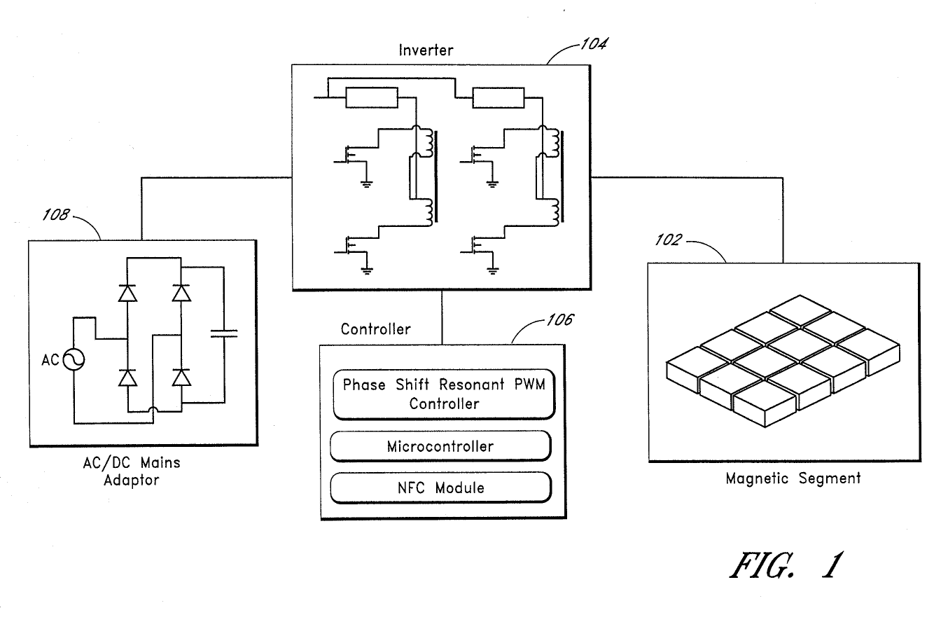

One embodiment is directed to a new generation is wireless power transfer. FIG. 1 illustrates one embodiment. The primary-side magnetic surface includes a mosaic of high-permeability micro-tiles. Cores for the micro tiles can be made from a high permeability material, such as ferrite. Other materials can be used. In one embodiment, the relative permeability of the material for the core is at least 20.

The use of 12 tiles is for illustrative purposes and is not intended to be limiting. These tiles can vary in size, for example, between 3-5 mm in thickness, and 10-20 mm in length and width. These dimensions are intended to be illustrative and not necessarily limiting. These micro-tiles form a magnetic segment 102 or array of micro-tiles. This segment 102 is powered by a switched mode power electronics circuitry, which includes an inverter 104 and a control system 106. The switched mode power electronics circuitry in turn receives a DC input from the mains adapter 108 which plugs directly into a 100-240V mains socket (typically AC). The illustrated embodiment is based on the operation of switched mode power supplies.

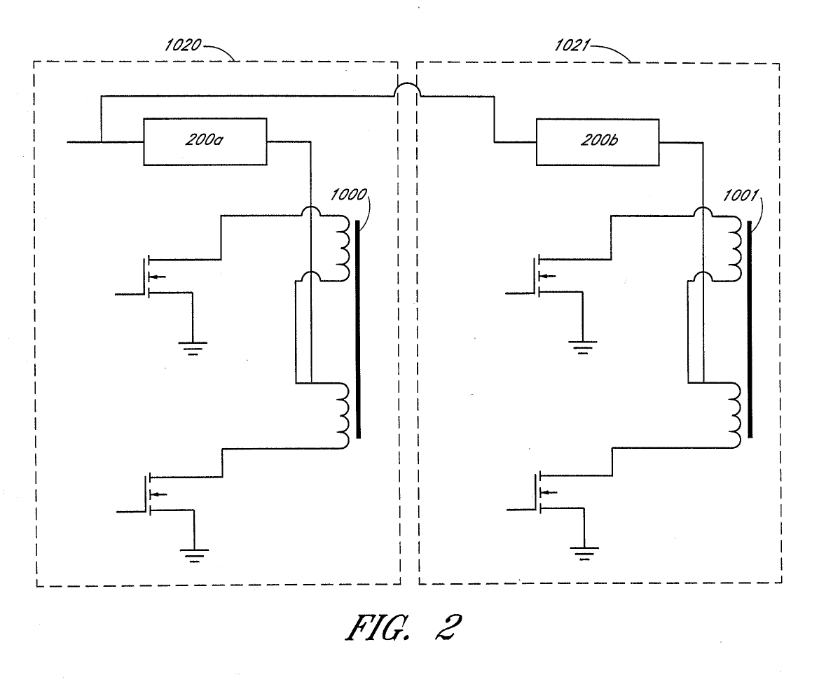

FIG. 2 illustrates an example of an inverter circuit (104 FIG. 1). It has a double push-pull configuration which, in the illustrated embodiment, includes two separate push pull circuits 1020 and 1021 respectively sharing the same DC source. The illustrated transformer's primary windings 1000 and 1001 are of a center-tapped topology. Other topologies are applicable. One advantage of the push-pull circuit is that there is typically only one switch conducting at any instant of time, as opposed to multiple switches in series. This can be useful if the DC input to the converter is from low voltage source, where the voltage drops across more than one switch in series would result in a significant reduction in energy efficiency. Another advantage is that the control drives for the two switches have a common ground.

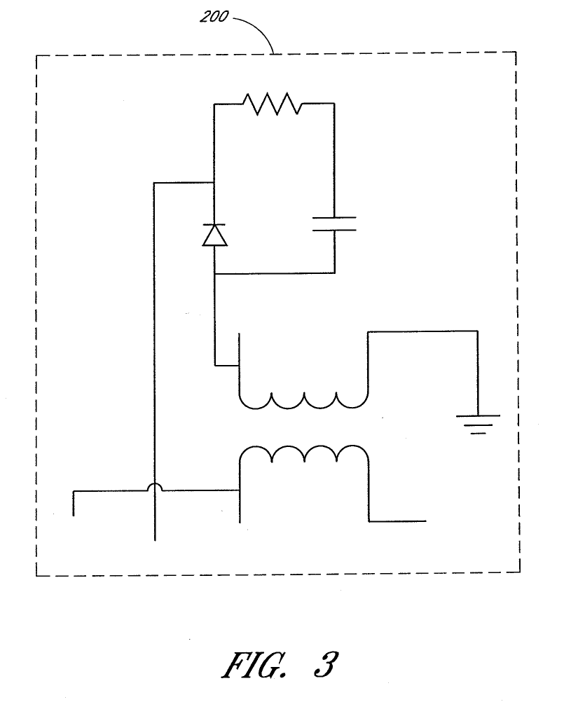

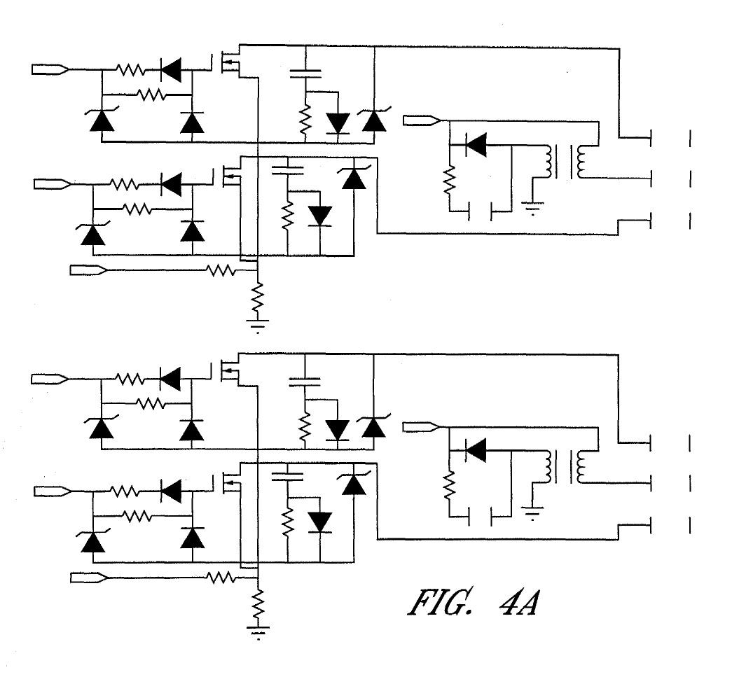

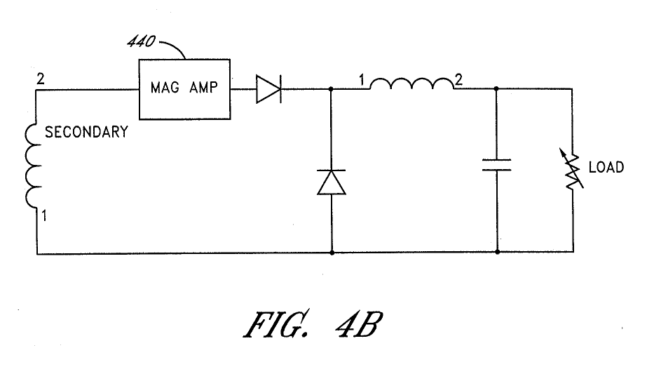

A possible disadvantage of this configuration is the possibility of DC saturation of the magnetic cores, which is overcome by introducing the anti-saturation inductors circuit 200a and 200b shown in FIGS. 2 and 3. In the illustrated embodiment, in the event of imbalance between the push-pull magnetic cores, a DC voltage will be built up across the anti-saturation choke/inductor thereby saturating it. The fly-back action on the secondary of the choke will return the energy stored to prevent the saturation. The purpose of the double push-pull topology is to individually control two separate sets of core windings as will be explained in the following paragraph about the magnetic cores arrangements. A more detailed circuit diagram of the inverter with the anti-saturation inductor applied to the center-tap of the primary winding is illustrated in FIG. 4A. Other topologies are applicable and will be readily determined by one of ordinary skill in the art.

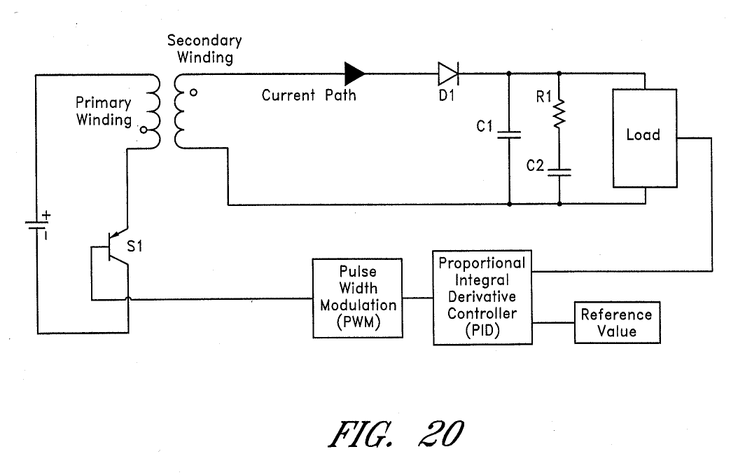

FIG. 4B illustrates an example of a secondary circuit. The secondary floating unit that is to be installed in various types of portable devices includes a magnetic amplifier 440, a rectifying circuit, microcontroller and a current source circuit will be described in further detail later in connection with FIG. 19. The secondary floating unit can include a winding around a high permeability core, e.g., a ferrite core. The mag amp can correspond to, for example, a saturable reactor (a non-linear inductor) to limit the power that is inductively coupled. With the assistance an adaptive control technique, such as parameter scheduling, the microcontroller can be pre-programmed with a suitable set of parameters to determine the required characteristic of individual battery types.

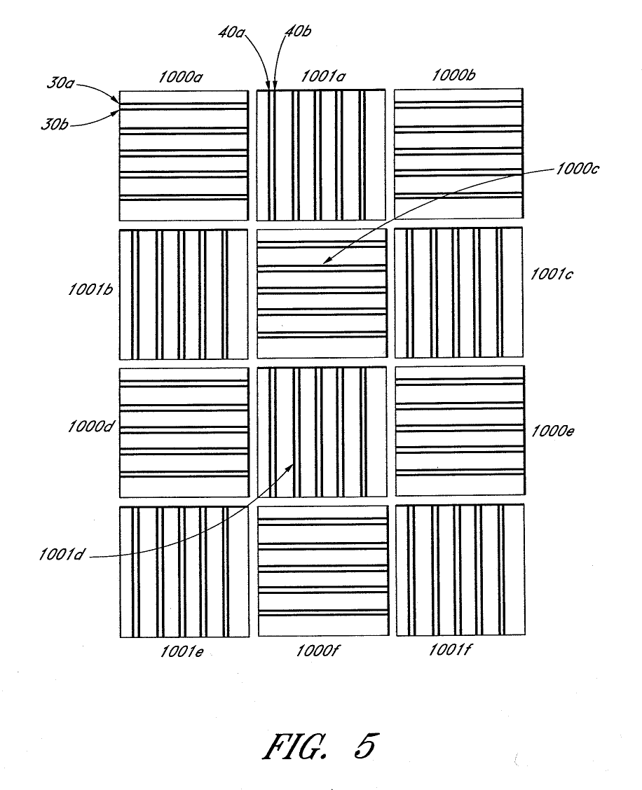

FIG. 5 shows one segment of the magnetic charging surface of the core or tile windings. In the illustrated embodiment, there are two types of windings: the horizontal wound tiles 1000a-f and the vertical wound tiles 1001a-f. These types of windings are placed alternately as shown. The windings of horizontally wound cores are connected together in series preferably in the sequential order from 1000a to 1000f. Likewise the vertical windings are connected together in the same way from 1001a to 1001f. Other configurations, such as diagonal windings, are possible.

It should be noted that each tile is bi-filarly wound with two wires. Multi-filar windings are applicable. The horizontal tiles have wires 30a and 30b while the vertical tiles have wires 40a and 40b respectively. These wires arrangement give the center-tapped topology as previously explained, which is used for the push-pull configuration. With both the horizontal and vertical wound cores being driven by a push-pull resonant circuit each. The bi-filar winding technique provides a uniform distribution of flux swing during operation.

For the control of the pulse-width modulation of the double push-pull inverter, a phase shift resonant controller can be used. This type of controller implements control by phase shifting the switching of one-half of the double push-pull inverter with respect to the other. This feature is used for the generation of the rotating magnetic field such that the inductive power transfer can occur independently from the orientation of the secondary device. By adjusting the phase shift of the two fields, the magnitude of the rotating magnetic flux density can be varied.

The rotating magnetic field is a principle in the operation of alternating-current motors. A permanent magnet in such a field will rotate so as to maintain its alignment with the external field. This effect was conceptualized by Nikola Tesla, and later utilized in his, and others, early AC (alternating-current) electric motors. A rotating magnetic field can be constructed using two approximately orthogonal coils with about a 90 degrees phase difference in their AC currents.

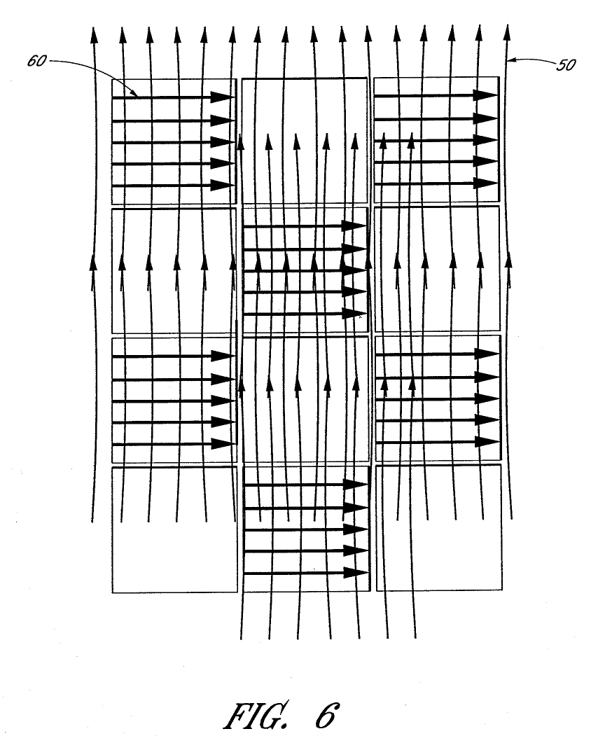

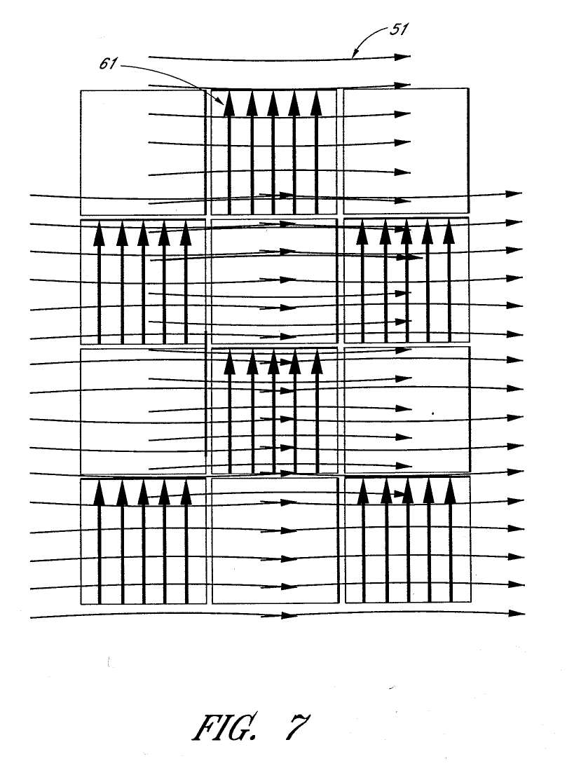

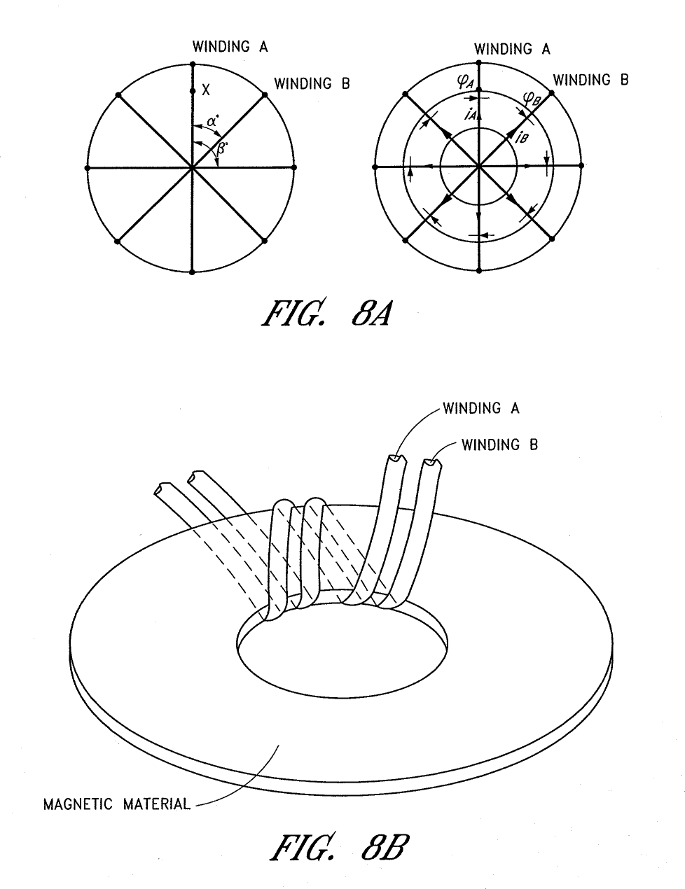

FIG. 6 illustrates a magnetic flux field 50 generated by the currents 60 of the windings of the cores, wherein the windings are horizontal with respect to the drawing. These windings will be referred to as horizontally wound.

FIG. 7 illustrates a magnetic flux field 51 generated by the currents 61 of the windings of the cores, wherein the windings are vertical with respect to the drawing. These windings will be referred to as vertically wound. By placing these cores (the horizontally wound and the vertically wound cores) in an alternating fashion, a single layer multi-directional windings can be achieved. These two alternating perpendicular windings can create a rotating magnetic field when they are powered using phase shifted switching waveforms as mentioned previously in the double push-pull configuration. One half of the double push-pull 1020 is configured to power the horizontal wound core while the other half 1021 is configured to power the vertical wound cores.

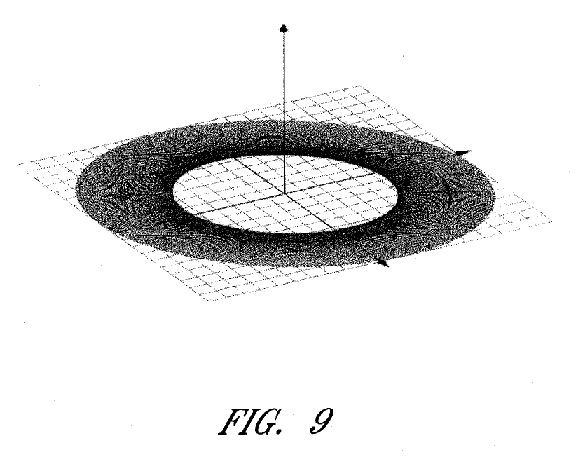

FIG. 8A illustrates how a rotating magnetic field is achieved by using two phase shifted magnetic flux fields arrange in perpendicular to one another. A mathematical proof follows. The flux field generated from the first winding is represented in Equation 1.

φ_{A}Φ cos ωt (Eq. 1)

The flux field generated from the second winding is represented in Equation 2.

φ_{B}=Φ cos(ωt+δ) (Eq. 2)

In Equation 2, δ represents the displacement between the two generating fields. From point X, the effective flux from all the adjacent turns of the same winding A can be expressed as in Equations 3A-3C.

$${φ}_{AR} = \sqrt{{φ}_{AH}^{2} + {φ}_{AV}^{2}} sin \{ {tan}^{- 1} ( \frac{{φ}_{AV}}{{φ}_{AH}} ) \} \\ {φ}_{AH} = \begin{matrix}Φ cos ω t + Φ cos ω t cos β + \\ Φ cos ω t cos 2 β + … Φ cos ω t cos n β\end{matrix} \\ {φ}_{AV} = Φ cos ω t sin β + Φcos ω t sin 2 β + … Φcosω t sin n β \qquad ( Eqs . 3 A \text{-} 3 C )$$

Again from the point X, the effective flux from all adjacent turn from winding B can be expressed as in Equations 4A-4C.

$${φ}_{BR} = \sqrt{{φ}_{BH}^{2} + {φ}_{BV}^{2}} sin \{ {tan}^{- 1} ( \frac{{φ}_{BV}}{{φ}_{BH}} ) \} \\ {φ}_{AH} = \begin{matrix}Φ cos ( ω t + δ ) cos α + Φcos ( ω t + δ ) cos 2 α + \\ … Φcos ( ω t + δ ) cos n α\end{matrix} \\ {φ}_{AV} = \begin{matrix}Φcos ( ω t + δ ) sin β + Φ cos ( ω t + δ ) \\ sin 2 β + … Φcos ( ω t + δ ) sin n β\end{matrix} \qquad ( Eqs . 4 A \text{-} 4 C )$$

The total resultant flux at point X can be represented by the Equation 5.

φ_{R}φ_{AR}φ_{BR} (Eq. 5)

From the equations, it can be seen that the phase and magnitude of the flux are functions of time and therefore, the phase of the flux can be rotated through a 360 degrees angle. Flux received by the secondary device is relatively uniform and the signal strength is relatively consistent regardless of orientation.

FIG. 8B illustrates a perspective view of separate windings around a magnetic core. One embodiment of the system comprises a primary unit with at least two windings for generating electromagnetic fields that are displaced at a predetermined angle across an approximately two-dimensional primary power transfer surface covered by the generated magnetic field.

FIG. 9 illustrates a simulation of a resulting field sweeping in all directions. The methodology of the alternating approach in this core arrangement can be explained from FIGS. 6, 7 and 8A. When one half the cores are being powered, the adjacent cores will also have been induced a magnetic flux field of the same direction even though they have windings of a different orientation. When the core segments with the two different windings are being powered concurrently with two phase-shifted magnetic flux fields, each tile has its own powered magnetic flux field and an induced field by the adjacent windings. Therefore, there exists a resulting field that rotates as shown in FIG. 9 that sweeps in all directions. When a secondary device is placed in the vicinity of the rotating field, inductive coupling or power transference can occur regardless of the orientation of the secondary magnetic windings.

One objective is to have the maximum utilization of core flux swing before entering saturation. The magnetic flux density is affected by the operating frequencies, cross sectional area of the cores, the applied voltage and the number of turns in the windings. The number of turns per tile can vary in a relatively wide range. In one embodiment, a fixed number of about 5 turns is used, but other numbers of turns will be readily determined by one of ordinary skill in the art. In one embodiment, as the number of tiles in series is increased, the number of turns will in turn increase at the same time. Since each turn has the same cross sectional area, this parameter becomes a constant. Therefore, increasing the number of turns will in effect reduce the magnetic flux density swing.

This phenomenon allows one embodiment to control the magnetic flux swing to pull it away from saturation. However, for maximum transference of inductive power, it is preferable to have a maximum allowable magnetic flux swing. This is controlled by adjusting the frequency to an optimized value. Typically, the larger the magnetic segment, the lower the operating frequency of the power circuitry, and lower switching losses and higher efficiency. This advantage of the micro-tiles arrangement, where an increase in size does not affect the efficiency, is very rare in switched-mode power supplies. Another advantage is in the flexibility of the arrangement. Segmentation into micro-tile design can render a piece formed from high permeable materials flexible and accommodative of a variety of shapes. Moreover, the alternating checkered arrangement gives the benefits of 1) single layer multi-directional windings for generating a rotating field; 2) permeability of the material is maintained with a minimum amount of air-gap in between cores/tiles in series and 3) flux distribution is uniform with the mutual induction of the vertical and horizontal winding arrangements.

The foregoing description is based on the fundamental operations of the embodiment producing a rotating magnetic field in a relatively two-dimensional primary surface; that is flexible and modular. When a secondary magnetic assembly (device with a secondary winding) is placed in the vicinity of the magnetic field, inductive power transfer can occur. This secondary device includes a secondary winding that can be inductively powered by the primary winding of the base station. The assembly can include a minimum of one magnetic winding, rectifier circuits, some discrete components and additional analogue circuitry to perform functions such as battery charging or providing power to appliances.

In one embodiment, the control circuitry is embedded with a microcontroller and a Near Field Communications IC. The microcontroller is used for basic house keeping for example short circuit protection, over-voltage protection and temperature control. There is relay switch that switches the device on or off. In the event of potential system failure, the microcontroller can send a signal to the relay switch to turn the device off.

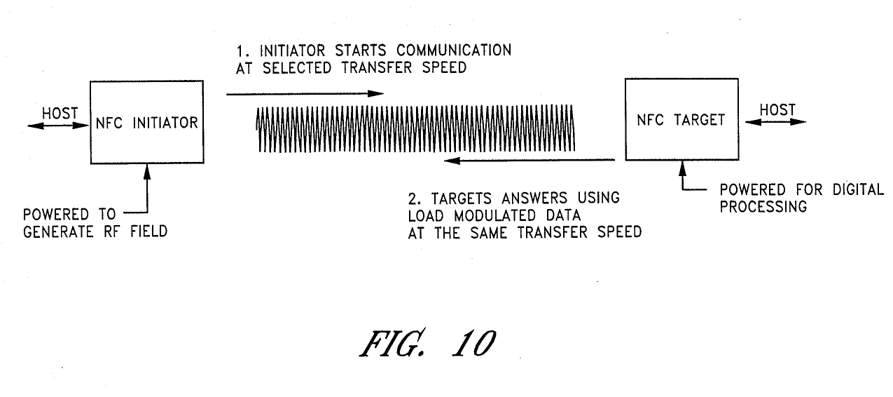

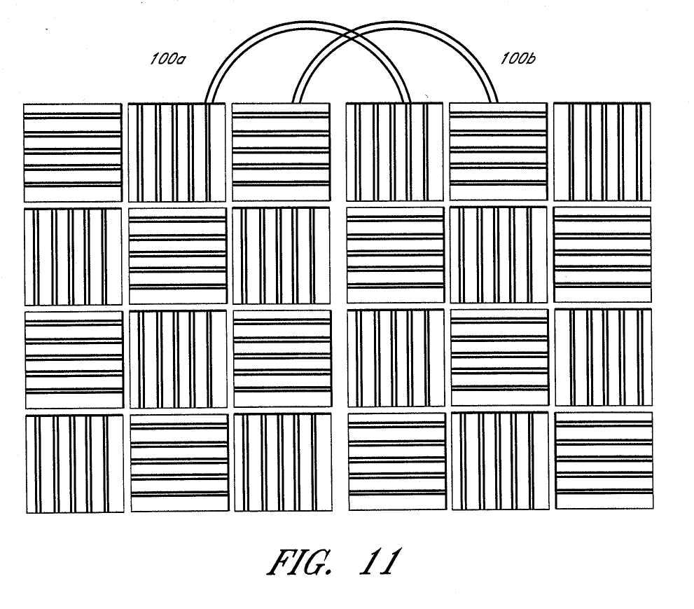

Near Field Communication Technology or NFC, is a short-range wireless technology. The NFC IC used is a highly integrated transmission module for contact-less communications at 13.56 MHz including microcontroller functionality. This transmission module combines an outstanding modulation and demodulation concept completely integrated for different kinds of contact-less communication methods and protocols at 13.56 MHz. In one embodiment, this IC is used in the passive mode such that the target answers to an initiator command in a load modulation scheme. The initiator is active, i.e., generating an RF field. The communication diagram is shown in FIG. 10. In this embodiment, the target is placed in the secondary assembly while the active initiator is embedded into the primary controller of the magnetic segments. The active RF coil is placed the surface of the magnetic segments to detect the presence of a secondary device. If a secondary device is detected, the transmission NFC module will send a signal to the microcontroller to tell it to turn the power electronics circuitry on. This aspect of the embodiment prevents unnecessary power wastage when the primary charger is not in used.

In another embodiment, two magnetic segments 100a, 100b are connected together to form a larger surface area for the primary as shown in FIG. 11. In the illustrated embodiment, the horizontal wound cores on both of the magnetic segments are connected in series, and the vertical wound cores on both of the magnetic segments are also connected in series. The maximum magnetic flux swing is achieved by calibrating the switching frequency. Every combination of magnetic segments gives a different parasitic capacitance. Due to the presence of leakage inductance in the primary windings, there exists a frequency where maximum transference of power can occur. This is the resonant frequency of the device. In a different embodiment, averaging inductances are introduced into the power circuitry to reduce the peak current to attain better efficiency.

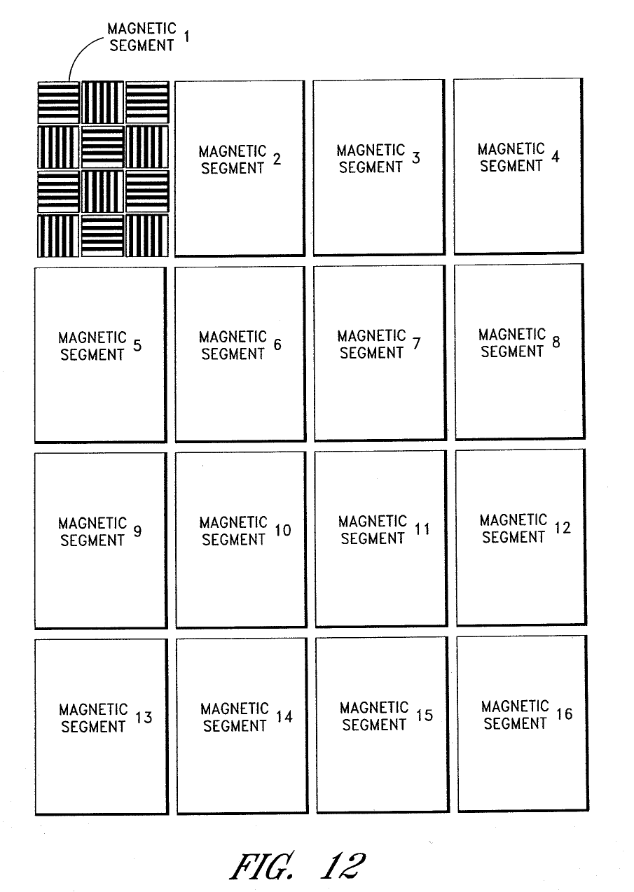

A larger surface area enables more than one device to be charged at the same time. The ability of the magnetic surface primary to produce power for the inductive transfer depends mainly on the applied voltage and the rating of the components used in the design of the primary power electronics circuitry. A larger surface area allows more devices to be charged at the same time, and typically uses a higher device ratings. In some embodiments, as shown for example in FIG. 12, more than 10 magnetic segments, more than one double push-pull power circuitry and controller circuitry can be used to power individual sections in one combined large charging surface. This is to limit the energy consumption per charging module and to reduce the heat dissipation of the entire assembly. As previously described, the magnetic segments can be joined serially to increase the number of turns and reduce the magnetic flux swing. However, this reduces the magnetic flux density of the charging surface and eventually reduces the maximum power transfer from the primary to the secondary.

To calibrate the design for a relatively good, such as an optimal transference of inductive power, it is preferable to connect the number of magnetic segments in use with an equal number of them in series as well as in parallel. This makes the distributed magnetic field intensity to be the same for the larger number of magnetic segments as their smaller counterpart. This is shown in FIG. 12 where magnetic segments 1-4, 5-8, 9-12 and 13-16 are connected in series within each group (e.g., 1-4) and each of these series chains are connected together in parallel. For a fixed operating frequency, this aspect can keep the need for calibration to the minimum. When a system is tuned for a magnetic segment to work at a particular switching frequency, by connecting them in this fashion, typically will not need adjustments in the operating frequency.

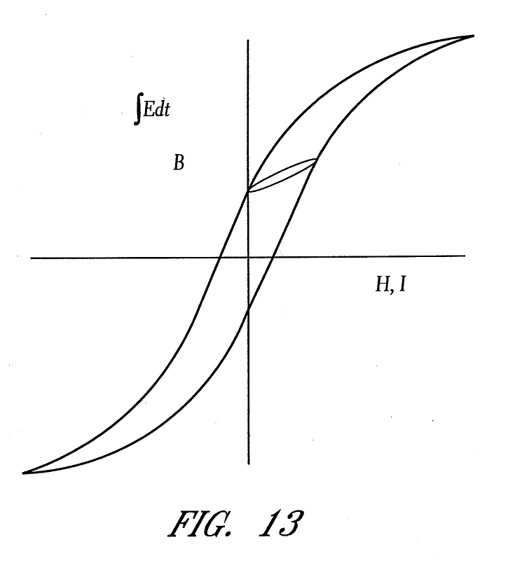

The magnetic field strength/intensity determines the effective distance for which magnetic inductive coupling can occur when a secondary assembly is placed in the region of the magnetic field. Magnetic field intensity in space around an electric current is proportional to the electric current which serves as its source. The magnetic surface can be explained using the analogy of a transformer driving an open circuit or without load; there exist a magnetizing current which varies through the switching period. The amount magnetizing current can be determined using the core B-H characteristic shown in FIG. 13. While the power is switched on, flux density B increases at a constant rate (which is determined by primary volts per turn along the minor hysteresis loop. This results in the corresponding change in field intensity H. Integrating the field intensity on the total magnetic path length through the core defines the magnetic force. According to Ampere's Law the magnetic force equals Ampere-turn enclosed by the magnetic path. Thus, the instantaneous magnetizing current is calculated from the field intensity. With a high permeability core the field intensity is relatively small. Magnetizing current represent energy stored in the magnetic core. When the power switch turns off, much of this energy (inside the minor hysteresis loop) becomes core loss. The remaining energy results in a voltage spike across the power switch, typically absorbed by a snubber or clamp to protect the power switch. The flux swing and the resulting magnetizing current is a function solely of volt-seconds per turn applied to the primary, independent of load current. During the power switch ON time, flux density increases linearly with time according to Faraday's Law because the applied primary voltage is constant. However, field intensity and magnetizing current change in a nonlinear manner, depending upon the shape of the B-H characteristic.

One aspect is the introduction of multiple air-gaps into a relatively high permeability magnetic segment as illustrated by the micro-tile configuration. This reduces the effective permeability of the magnetic primary and thereby increasing the magnetizing current as well as the magnetizing field intensity. To further increase this magnetic field intensity, the magnetizing current can be increased. This can be achieved by increasing the applied voltage as magnetizing current is a function of volt-seconds per turn or by reducing the operating frequency of the switch mode inverter. Therefore the input voltage of the inverter plays a role in the control of the field intensity. This voltage indirectly determines the distance of the effective coupling of the secondary device.

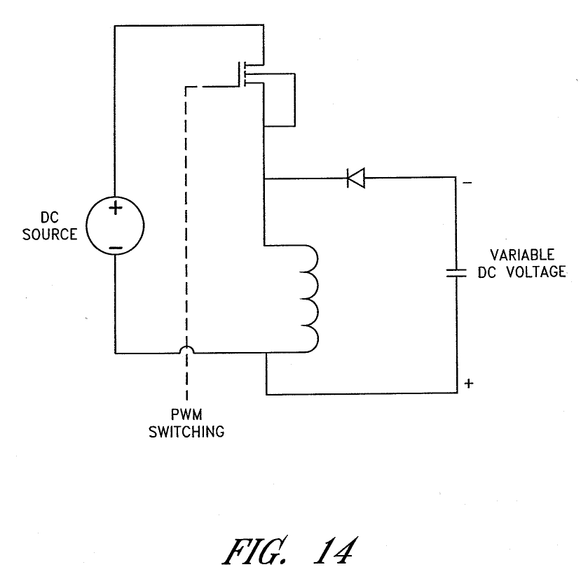

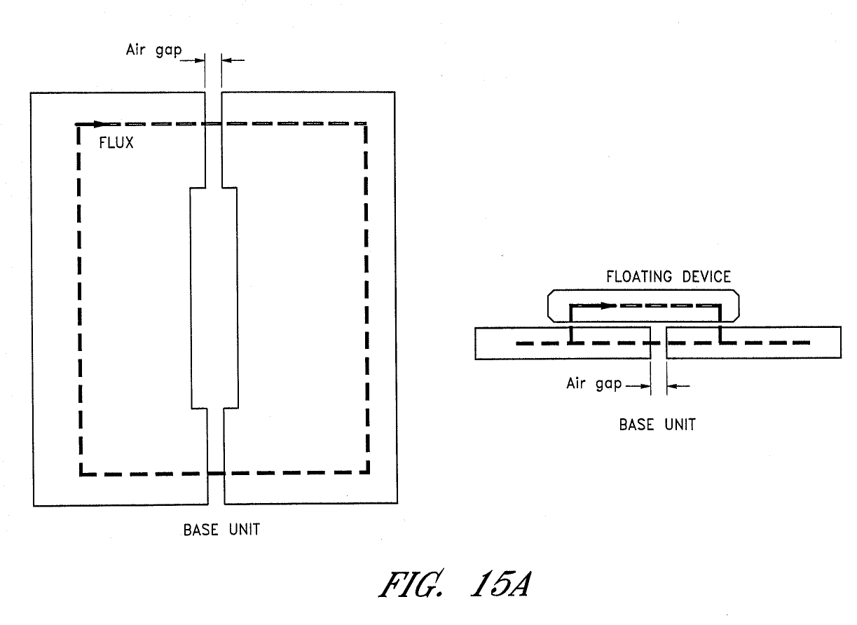

In one embodiment, a buck-boost converter is used at the input end of the double push-pull inverter to vary the applied voltage of a magnetic segment as shown in FIG. 14. The buck-boost generates a negative polarity output with respect to the common terminal of the input voltage, and the output can either be higher or lower than the input voltage. A separate SMPS (switch mode power supply) PWM (pulse width modulator) controller is used for the switching of the buck-boost converter. Information of the required voltage can be stored on the NFC target on the secondary device assembly. When the secondary device is placed in the region of the magnetic field, this information will be sent across to the microcontroller on the primary. The microcontroller together with a D/A converter circuitry will generate the required voltage for appropriate magnetic field intensity. The feature is attractive due to the optimization of magnetizing current drawn with the demand of secondary device. As mentioned previously, magnetizing current represents the energy stored in the magnetic core and eventually becomes the core loss. By controlling the applied voltage according to its usage, power wastage can be greatly reduced.

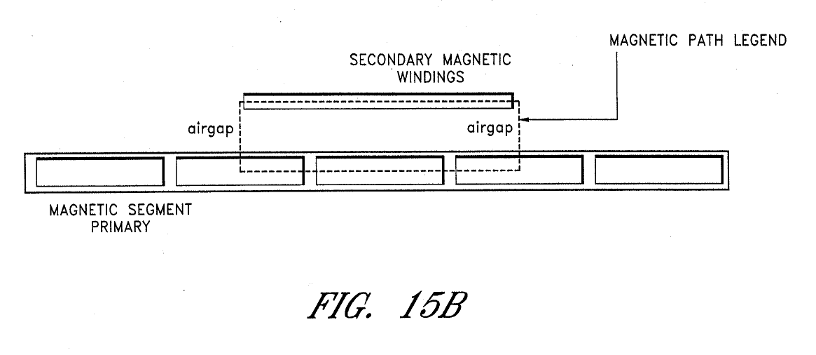

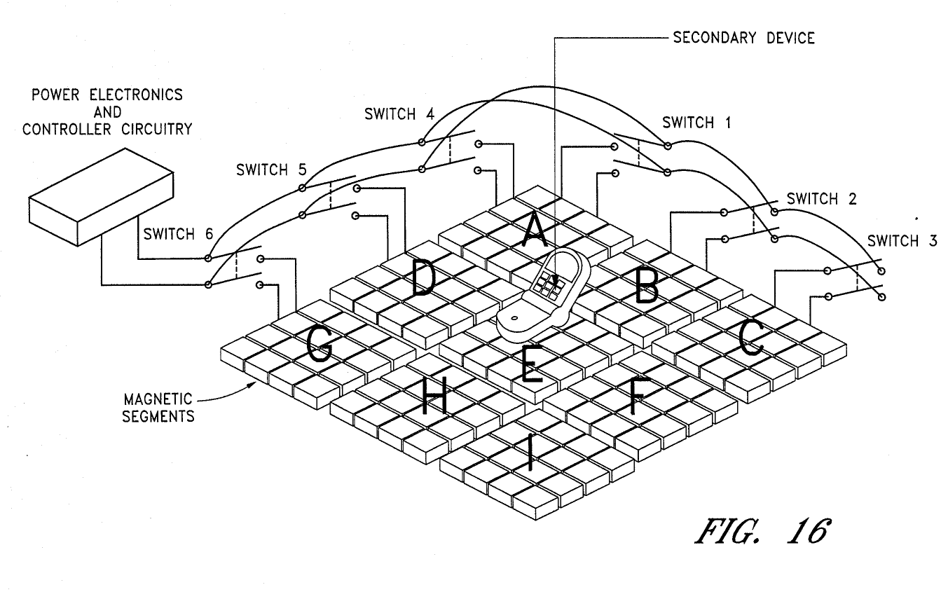

FIG. 15A illustrates an alternative configuration with two C-shaped cores. With this arrangement, one or more gaps are deliberately introduced between the cores. The gap is void of highly magnetically permeable material. For example, the gap can be an air-gap as illustrated in FIG. 15A, can be filled with a spacer of plastic, wood, rubber, non-permeable metal, ceramic, and the like. This increases the reluctance of the core, but is compatible with a single layer multi-filar winding. As a majority of the magnetic flux flows in a path with the least reluctance, relatively more flux will travel vertically through the floating device making the power transference more effective and efficient. The secondary floating device should be positioned in the proximity of the gap for power transfer.

FIG. 15B illustrates a side view of power transfer from micro-tiles, e.g., side view of a micro-tile segment, to a floating device having secondary windings. When a load is applied to the secondary winding (occurrence of inductive power transfer), current is induced in the primary in addition to the magnetizing current. The additional primary Ampere-turns are equal to the magnitude of secondary Ampere-turns (resulting from the load) opposite in phase plus the magnetic force due to the gap between the primary and secondary windings as shown in FIG. 15B.

The gap (of non-permeable matter, such as air, plastic, rubber, etc.,) between windings is a location within the magnetic structure where the primary and secondary ampere turns do not cancel. The magnetic force appears almost entirely along that portion of the path between the windings because the permeability in that non-magnetic region is much less than in the remainder of the path. The flux resulting from this magnetic force between the windings completes its path is sometimes known as the leakage flux. From a circuit point of view, the energy storage capability of the magnetic field between the windings is called leakage inductance. Leakage inductance energy is proportional to load current squared. When the power switch turns off, current in the windings collapses. A snubber is used to absorb the leakage inductance energy and prevent damage to the power switch. Even though leakage flux density is much less than magnetizing flux density, leakage inductance energy at full load is usually much greater than magnetizing inductance energy. This is because the leakage field exists in the region between the windings where permeability is relatively low. Thus, even though flux density is relatively low, field intensity is relatively great. For effective inductive power transference to occur from the primary to the secondary, the permeability of the secondary magnetic material should be able to sustain to the flux density sufficient to produce a voltage. Therefore materials with relatively high permeability can be used, such as nanocrystallines or high permeability ferrites.

To give a better perspective, a further alternative embodiment will now be described. In one embodiment, a magnetic entity is made up of a sixty micro-tile flexible magnetic segment, a buck-boost DC to DC converter, a double push-pull inverter, control circuitries (phase shift resonant controller and a SMPS PWM controller), a microcontroller, an NFC (near field communication) module and other analog circuitries. This embodiment combines nine magnetic entities to a form one relatively large magnetic charging or powering surface. If multiple devices are placed on this surface for charging at the same time, each NFC target will send the required information to the primary reader with the closest proximity. Each magnetic entity will generate a magnetic field with respect to the demand. In an event when more than one target sends information to the same primary reader, the microcontroller can perform a calculation for that magnetic segment to generate a magnetic field powerful enough for both. This permits, for example, a controller to turn on only the applicable portions of the magnetic charging or powering surface to save power, rather than applying power to the entire charging or powering surface.

In another embodiment, an array of relay switches is used to connect nine magnetic segments together as shown in FIG. 16. Only one entity of power circuit segment is used in this example. In the illustrated embodiment of FIG. 16, each magnetic segment includes sixteen micro-tiles. A selected magnetic segment of the entity can be powered separately using coordinated combination of relay switches. These relay switches permit the selection of a magnetic segment by column and row in the array. These switches can be mechanical or electronic and perform a multiplexing task, which allows one power circuit to power up a selected magnetic segment.

For example, if switches 1 and 4 are on, segment A is activated. If switches 3 and 5 are on, segment F is activated Embodiments of the invention are not limited to sixteen micro-tiles per magnetic segment or nine segments per charging surface. There can be as many segments allowable by the rating of the power devices used. Near field techniques can be used to select the applicable segment for powering. In one embodiment, the various segments of the array can be cycled through, and the load of the floating secondary sensed to determine which segment, if any, should be activated for charging or powering a load. Other techniques are applicable. For example, a pressure switch can be used.

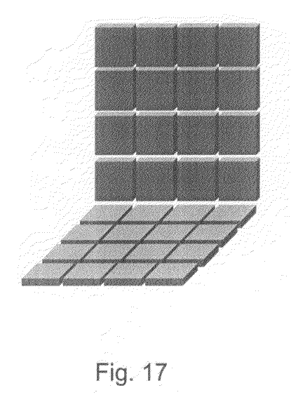

In one embodiment, due to the fact the nature of the micro-tile magnetic segments of the primary charging is surface can be relatively flexible (e.g., flexible material can be used in the non-high permeability gaps), it can take the form or shape of any three-dimensional objects; for example, a bowl, a pedestal or any other container types. Of course, the micro-tile magnetic segments can also be rigid if desired. This aspect of the embodiment will be able to create a three-dimensional magnetic field using a two dimensional generating technique. One embodiment is shown in FIG. 17.

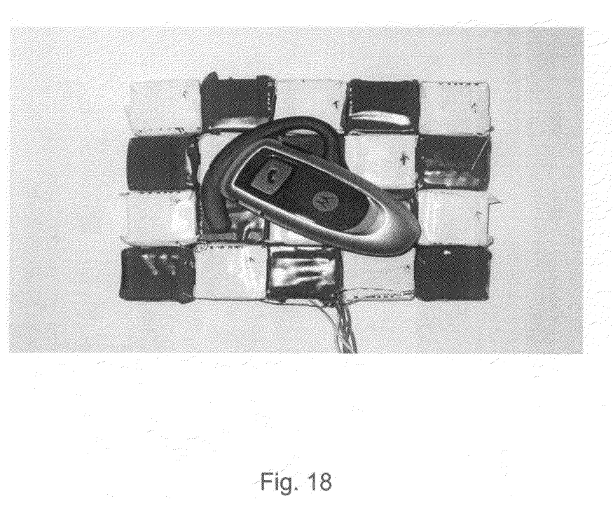

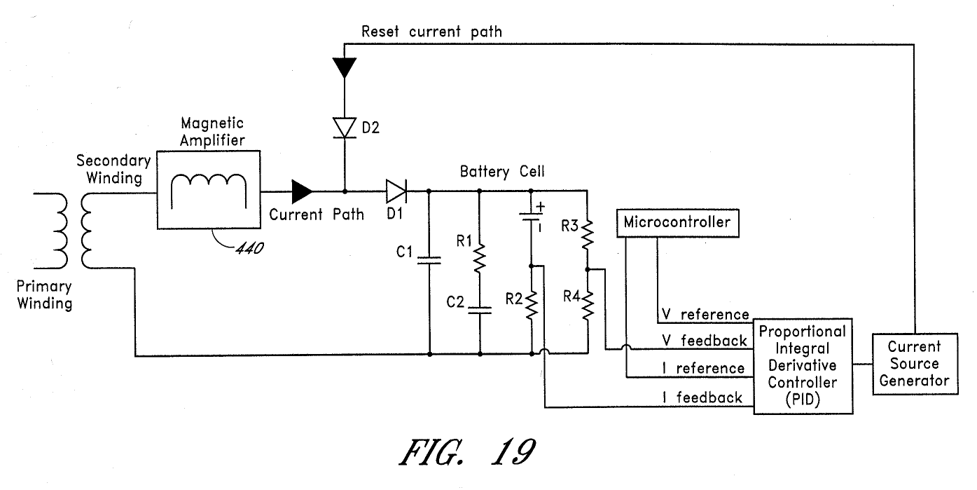

FIG. 18 shows a mobile Bluetooth headset being charged on magnetic segment. The light tiles are the horizontal wound cores while the dark tiles are the vertical wound cores.

Secondary circuits that receive inductively coupled power will now be described. In typical non-wireless power supplies, one secondary output voltage is regulated closed-loop to the primary, while other secondaries remain open loop. With a single primary for generating the electromagnetic flux field, e.g., the charging surface, there can be multiple secondaries when charging more than one device at a time. Although, feedback can be provided via a wireless communications technique, such as Bluetooth or NFC, this will typically reduce the available bandwidth desired for relatively good control performance. Moreover, as mentioned before, multiple secondary closed-loop control is not feasible using this strategy because the primary side is controlled. In one embodiment of the invention, a magnetic amplifier, which is a type of saturable reactor or saturable inductor, is introduced into the design of the secondary charging circuitry. The magnetic amplifier offers a low cost regulation principle that is efficient, closed-loop and yet independent of the primary. By employing parameter scheduling adaptive control technique together with the magnetic amplifier, it is possible create a universal charging circuitry for wireless inductive battery charging.

FIG. 19 illustrates an embodiment of the invention of a secondary side of a wireless charging circuit that can be embedded with a battery or battery pack. The illustrated embodiment includes a coil winding, a magnetic amplifier 440, transformer isolated converter configuration. FIG. 19 illustrates a Fly-back converter topology together with their driving circuitries, diodes, output low-pass filter and a microcontroller. The embodiments described in this disclosure have the circuitries and windings integrated in the batteries or battery packs. For example, in one embodiment, it is incorporated with lithium polymer battery cells to form the integrated batteries or battery packs.

FIG. 19 depicts a fly-back converter together with a magnetic amplifier 440 and control circuitries that is capable of performing closed loop control within the secondary for charging a battery cell wirelessly. D1 is a diode used for rectification. C1 is an output filter capacitor. R1 and C2 provide resonant damping. R2, which is connected in series with a battery cell, is used to sense the charging current for feedback control. R3 and R4 form a voltage divider circuit to sense the battery voltage for the voltage feedback. The microcontroller can provide reference values typically determined by the device manufacturer or by the battery manufacturer for an individual battery requirements. In one embodiment, these reference values are preprogrammed. With the use of a Proportional Integral Derivative (PID) Controller, a control value will be used by the current source generator to produce a reset current that is injected in the opposite direction to the original current path to control the pulse width of the magnetic amplifier 440.

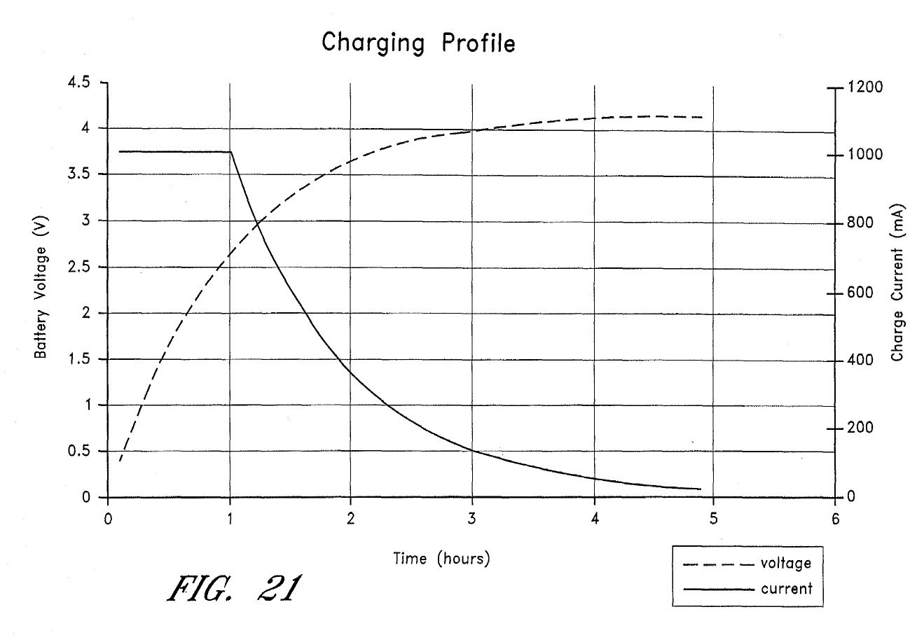

The principles of operation of this embodiment will initially be described without the magnetic amplifier 440 s shown in the model of FIG. 20. The illustrated circuit model behaves like the secondary of a fly-back converter. Alternating magnetic flux fields are picked up by the coil during wireless power transfer and converted into an alternating voltage source. This voltage is then rectified by a diode D1, e.g., a Schottky diode, and then filtered by capacitor C1 to obtain a DC voltage output which is then used to charge a battery. This configuration is used in a wired design where the feedback control is used to directly control the pulse-width of the primary switch S1.

The voltage level is relatively important when charging lithium ion or lithium polymer batteries as these batteries are typically charged from a fixed voltage source that is current limited. This method is also referred to as constant voltage charging. The charger sources current into the battery in an attempt to force the battery voltage up to a pre-set value. Once this voltage is reached, the charger will preferably source only enough current to hold the voltage of the battery at this constant voltage. The accuracy on the set point voltage can be relatively important: if this voltage is too high, the number of charge cycles the battery can complete is reduced. If the voltage is too low, the battery cell will not be fully charged. FIG. 21 shows a typical charging profile for a lithium ion battery cell using 1 A-hr constant voltage charging. The constant voltage charging is divided into two phases. The current limited phase of charging is shown to the left of FIG. 21, wherein the maximum charging current (e.g., 1 A) is flowing into the battery; due to the battery voltage is below the reference voltage (e.g., 2.65 Volts). The charger senses this and sources maximum current to try to force the battery voltage up. During the current limited phase, the charger should limit the current to no more than the maximum allowed by the battery manufacturer to prevent damage to the battery cells. About 65% of the total charge is delivered to the battery during the current limited phase of the charging. The constant voltage of the charge cycle begins when the battery voltage sensed by the charger reaches about 4.2V (the normal set point for lithium ion batteries). At this point, the charger reduces the charging current to hold the sense voltage constant at 4.2V resulting in a current waveform that is shaped like an exponential decay.

Voltage regulator integrated circuits for controlling the charging voltage are readily available and many of these regulators have a built in current limit circuit. However, these regulator devices typically need voltage trim resistors to function. Resistors by themselves have tolerances and the cumulative effect of the components will contribute error to the set voltage. In addition to the component tolerances, the circuitry with the trim resistors will continuously drain current from the battery, and although the current is relatively minute (in the region of 10 uA), it does reduce the standby time for portable products. There are currently on market, battery charger controllers that source current from its output when the regulated voltage is applied from input to ground. These are higher precision devices that do not require external voltage trims. However, this still does not provide a solution for a proper closed-loop voltage control. Different portable device batteries or just batteries have very dissimilar current carrying capacity and their behavior will vary from one to the other. The charging characteristics of the charger should match with those of the battery cells, e.g., it is not advisable to use a charging device with a fixed current limit and voltage to charge a lithium polymer battery cell. It is therefore crucial for precise closed-loop control of the charging voltage and current.

Closed-loop control is typically used in normal wired-circuitries. In a wireless system, feedback of the control parameters, i.e., sense of voltages and currents, is not possible through a wired route. Some designers have attempted other means of communication such as Bluetooth or by magnetic data transfer. These techniques are typically not viable because the rate of transmission via these channels is not fast enough for a proper control bandwidth to be obtained. The resultant feedback system will typically be either too slow or unstable for instance, overshoot transients, which is not ideal in the case of battery charging. A magnetic amplifier is advantageously used in the feedback loop.

The dynamics of a fly-back converter will now be described. Electrical isolation is achieved through placing a second winding in the inductor of a buck-boost converter. When the switch is on, due to winding polarities, the diode becomes reverse biased. After, when the switch is turned off, the energy stored in the inductor core causes current to flow in the secondary winding through the diode. The function of a magnetic amplifier can be described as a high speed on/off switch similar to a switching transistor. The core of the magnetic amplifier is typically made up of a soft-magnetic alloy having a rectangular hysteresis loop. The magnetic amplifier is relatively open, i.e. not very conductive, when the core is magnetized and the current to the output is blocked. When the core material is saturated, the magnetic amplifier is on, i.e., relatively conductive, and current starts to flow to the output. This effect is based on a rapid change in impedance of the choke. This switching function can be used for pulse width control of the voltage pulse induced in the respective secondary winding before rectification. In one embodiment, intervention takes place at the leading edge of the pulse induced in the respective secondary winding (before the pulse is rectified and smoothed by the output filter).

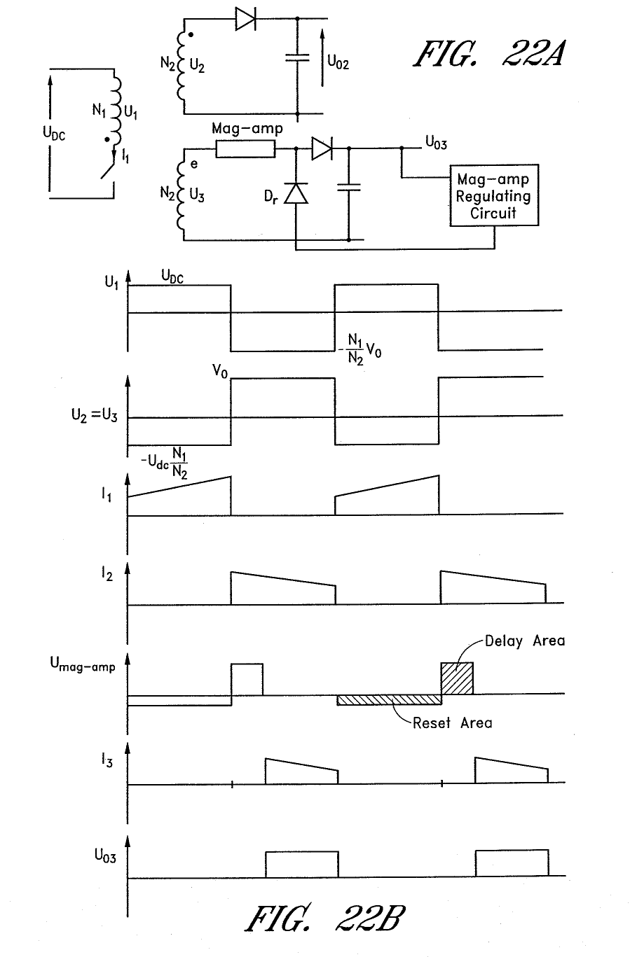

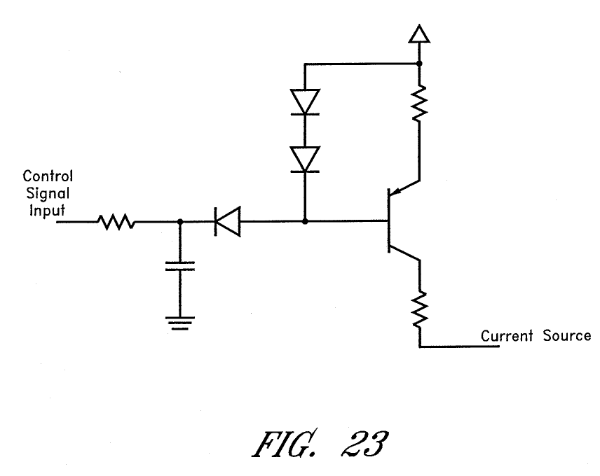

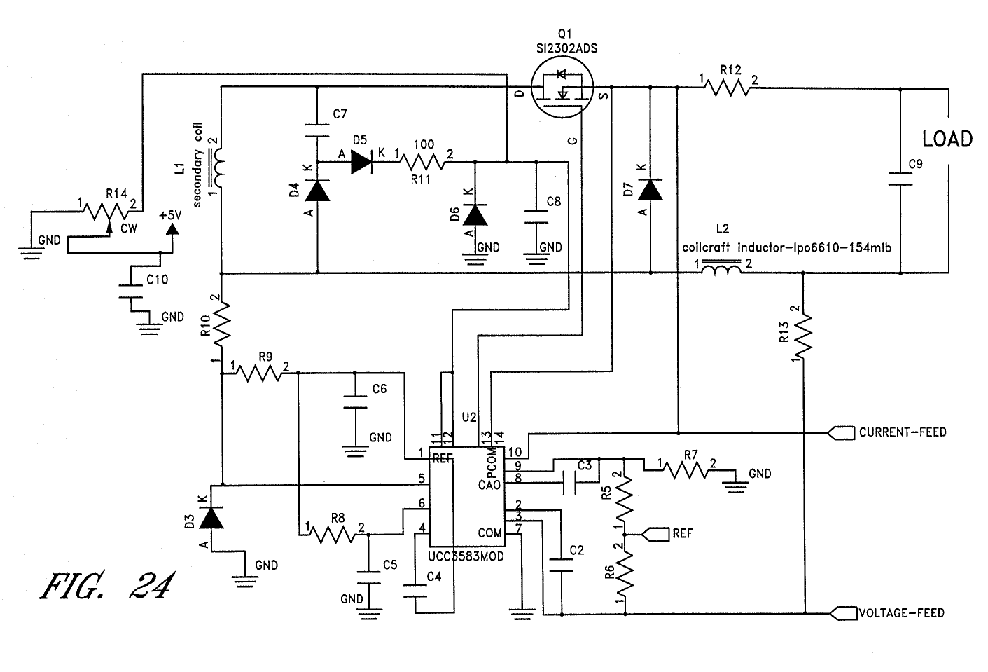

FIG. 22 provides an illustration of the operating principle when the magnetic amplifier is used in the fly-back circuit. FIG. 23 shows the detailed configuration of the current source generator where the control signal from the PID controller is translate into a useful current source signal to reset the magnetic amplifier. U1 is the voltage of the primary winding, U2 is the voltage of the secondary winding of a normal fly-back circuit and U3 is the voltage of the secondary winding that has a magnetic amplifier. As can be seen, the magnetic amplifier is placed in the circuit path before the rectification process through the diode. The closed-loop control mechanism is performed within the mag-amp regulating circuitry. Both the charging current and voltage can be regulated this way. When the reference value (current or voltage) is higher than the output value, the mag-amp regulating circuit will allow the magnetic amplifier to enter saturation to reduce the pulse delay by allowing more voltage to be rectified. On the other hand, when the reference value is lower than the output value, the mag-amp regulating circuit will produce a reset current in the opposite direction to the original current path that flows through the magnetic amplifier through diode D2 to reset the core of the magnetic amplifier, which then acts like an opened switch.

With the introduction of a magnetic amplifier or other control within the secondary circuit of the battery, multiple secondary closed-loop control can be achieved. For example, in one embodiment, rather than use the magnetic amplifier, a transistor, e.g., MOSFET, driven by a controller can be used to provide power or charging control. An example of such a controller is a switch mode secondary side post regulator with part number UCC3583 available from Unitrode Products. An example of such a circuit is illustrated in FIG. 14. In FIG. 14, Q1 is a MOSFET switch for control, and U2 is the controller chip. The controller chip U2 provides a gate drive for MOSFET Q1. Inductor symbol L1 represents a secondary winding for receiving wireless power. Various other components are for rectifying, current sensing, voltage sensing, and the like. Capacitor C9 can be coupled across the load in parallel, such as across a battery to be charged. The primary charging surface can provide a maximum duty ratio and the feedback control can be implemented accurately with, for example, a preprogrammed reference value within the microcontroller for various devices. For example, each rechargeable device, e.g., rechargeable battery pack or rechargeable portable device, can have its own locally regulated secondary circuit to provide relatively good charging performance from a shared primary charging surface.

Various embodiments have been described above. Although described with reference to these specific embodiments, the descriptions are intended to be illustrative and are not intended to be limiting. Various modifications and applications may occur to those skilled in the art.

What is claimed is:

1. An apparatus for providing wireless charging, the apparatus comprising:
a magnetic segment of 2 or more tiles, each tile having at least one winding having at least one turn, each time having a core of high magnetic permeability material, the magnetic segment having at least a first group of one or more tiles having winding(s) oriented in a first direction and a second group of one or more tiles having winding(s) oriented in a direction different than the first direction; and
an inverter configured to power the windings of the tiles.

2. The apparatus of claim 1, further comprising a non-magnetically permeable gap between each of the tiles.

3. The apparatus of claim 2, wherein the gap is between 0.5 mm and 2 mm.

4. The apparatus of claim 1, wherein the core is about 5 mm to about 30 mm in length and/or width.

5. The apparatus of claim 1, wherein the second direction is orthogonal to the first direction.

6. The apparatus of claim 1, wherein the first group of one or more tiles has horizontal windings and the second group of one or more tiles has vertical windings as viewed from above.

7. The apparatus of claim 1, wherein each of the windings in the first direction are coupled in a first series connection, and wherein each of the windings in the second direction are coupled in a second series connection, and wherein the inverter is configured to power the first series connection and the second series connection separately.

8. The apparatus of claim 1, further comprising an entity of a plurality of magnetic segments, wherein each of the plurality of magnetic segments is independently powered from the other magnetic segments.

9. The apparatus of claim 8, wherein each magnetic segment is coupled to a corresponding inverter.

10. The apparatus of claim 1, further comprising an entity of a plurality of magnetic segments, wherein at least two of the magnetic segments are switchably coupled to share a common inverter.

11. The apparatus of claim 10, further a control circuit configured to automatically select which magnetic segment to activate in response to a detection of a presence of a load to be powered.

12. The apparatus of claim 1, wherein the windings are multi-filar wound.

13. A method of providing wireless charging, the method comprising:
generating an AC magnetic field from a magnetic segment, the magnetic segment comprising 2 or more tiles, each tile having at least one winding having at least one turn, each time having a core of high magnetic permeability material, the magnetic segment having at least a first group of one or more tiles having winding(s) oriented in a first direction and a second group of one or more tiles having winding(s) oriented in a direction different than the first direction; and
generating AC current to power the windings of the tiles.

14. The method of claim 13, wherein the second direction is orthogonal to the first direction.

15. The method of claim 13, further comprising coupling each of the windings in the first direction in a first series connection, and coupling each of the windings in the second direction in a second series connection, and powering the first series connection and the second series connection separately.

16. The method of claim 13, further comprising combining a plurality of magnetic segments to form an entity, wherein each of the plurality of magnetic segments is independently powered from the other magnetic segments.

17. The method of claim 16, further comprising powering each magnetic segment with a corresponding inverter.

18. The method of claim 13, further comprising combining a plurality of magnetic segments to form an entity, and switching power to the magnetic segments such that at least two of the magnetic segments share a common inverter.

19. The method of claim 18, further comprising automatically selecting a magnetic segment to activate in response to a detection of a presence of a load to be powered.

20. An apparatus for receiving wireless power transfer, the apparatus comprising:
a winding configured to inductively couple power in a wireless manner;
a regulating device disposed in a current path of the winding;
a rectifier circuit configured to rectify alternating or pulsing current from the winding; and
a control circuit configured to control operation of the regulating device for regulation of at least one of voltage, current, or power received from the winding.

21. The apparatus of claim 20, wherein the regulating device comprises a magnetic amplifier.

22. The apparatus of claim 21, further comprising a reset circuit configured to reset a core of the magnetic amplifier.

23. The apparatus of claim 20, wherein the regulating device comprises an electronic switch, wherein the apparatus further comprises a post-regulating control circuit for control of the electronic switch.

24. The apparatus of claim 20, wherein the control circuit is configured to communicate with a base station to activate power to be received by the winding.

25. The apparatus of claim 20, further comprising a rechargeable battery or rechargeable battery pack, wherein the winding, regulating circuit, rectifier circuit, and control circuit are integrated with the rechargeable battery or rechargeable battery pack.

26. The apparatus of claim 20, wherein the apparatus is integrated with a mobile device for charging of an rechargeable battery of the mobile device.

27. A method for receiving wireless power transfer, the method comprising:
wirelessly inductively coupling to a source of power, thereby generating an internal source of alternating or pulsing current;
controlling a regulating device disposed in a current path of the alternating or pulsing current to regulate at least one of power, voltage, or current; and
rectifying the alternating current.

28. The method of claim 27, wherein the regulating device comprises a magnetic amplifier, further controlling the magnetic amplifier via a reset current that resets a core of the magnetic amplifier.

29. The method of claim 27, wherein the regulating device comprises an electronic switch controlled by a post-regulating controller.

30. The method of claim 27, further comprising communicating with a base station to activate power to be received by the winding.

31. The method of claim 27, further comprising performing the method in a rechargeable battery or rechargeable battery pack.

32. The method of claim 27, further comprising performing the method in a mobile device for charging of an rechargeable battery of the mobile device.
